(19) United States
(12) Patent Application Publication
(10) Pub. No.: US 2024/0372294 A1
(43) Pub. Date: Nov. 7, 2024

(54) CONNECTOR

(71) Applicant: Yazaki Corporation, Tokyo (JP)

(72) Inventors: Tomokazu Iwami, Kakegawa-shi (JP); Norihisa Yamada, Kakegawa-shi (JP)

(21) Appl. No.: 18/772,046

(22) Filed: Jul. 12, 2024

Related U.S. Application Data
(63) Continuation of application No. PCT/JP2023/008188, filed on Mar. 3, 2023.

(30) Foreign Application Priority Data
Mar. 9, 2022 (JP) 2022-036374

(51) Int. Cl. H01R 13/627; B60L 53/16; H01R 13/24

(52) U.S. Cl. CPC H01R 13/6271; H01R 13/2471; H01R 13/2492; B60L 53/16; H01R 2201/26

(57) ABSTRACT

A connector includes a terminal, a terminal holder, and a housing. The terminal holder includes a plurality of locking portions arranged in a circumferential direction of the terminal, the plurality of locking portions being elastically displaceable in a radial direction of the terminal and being capable of engaging with the terminal to restrict movement of the terminal in the radial direction and an axial direction. The housing includes a first pressing portion that presses the plurality of locking portions inward in the radial direction, and a second pressing portion that presses the terminal inward in the radial direction.

### CROSS-REFERENCE TO RELATED APPLICATIONS

This is a continuation of International Application No. PCT/JP2023/008188 filed on Mar. 3, 2023, and claims priority from Japanese Patent Application No. 2022-036374 filed on Mar. 9, 2022, the entire content of which is incorporated herein by reference.

### TECHNICAL FIELD

The present invention relates to a connector including a rod-shaped terminal, a terminal holder, and a housing on which the terminal holder is mounted.

### BACKGROUND ART

In the related art, a connector for power supply for supplying (charging) electric power from outside a vehicle to a battery mounted on a vehicle such as an electric automatic vehicle or a plug-in hybrid automatic vehicle has been proposed. The connector for power supply is connected to a power supply or the like outside the vehicle, and is connected to be inserted into a charging inlet provided in the vehicle (see, for example, Patent Literature 1). This type of connector is also called a charging connector.

### CITATION LIST

### Patent Literature

Patent Literature 1: JP6475669B

### SUMMARY OF INVENTION

In the above charging connector of the related art, a plurality of rod-shaped terminals are sequentially inserted into terminal accommodating chambers of a housing and temporarily fixed (so-called temporary locked), and then a rear holder is assembled to the housing, thereby finally fixing (so-called final locking) the plurality of terminals to the housing. Due to such a structure, at the time of assembling the rear holder, an assembling work is performed while preventing positional deviation or the like of the terminals temporarily fixed to the housing. As a result, it is difficult to improve workability in manufacturing the charging connector. Further, as can be understood from the above description, it is desired to improve the workability of assembling and manufacturing not only the charging connector but also a connector.

An object of the present invention is to provide a connector capable of improving workability of manufacturing the connector.

According to one aspect of the present invention, there is provided a connector including:
a rod-shaped terminal;
a terminal holder configured to hold the terminal; and
a housing to which the terminal holder is mounted, in which
the terminal holder includes a plurality of locking portions arranged in a circumferential direction of the terminal, the plurality of locking portions being elastically displaceable in a radial direction of the terminal and being capable of engaging with the terminal to restrict movement of the terminal in the radial direction and an axial direction, and
the housing includes one or more first pressing portions that press the plurality of locking portions of the terminal holder inward in the radial direction and a second pressing portion that presses the terminal inward in the radial direction.

### BRIEF DESCRIPTION OF DRAWINGS

FIG. 1 is a perspective view illustrating a state in which a terminal holder holding a terminal and a housing are separated from each other in a connector according to an embodiment of the present invention;

FIG. 2 is a perspective view illustrating a state in which a part of a plurality of components constituting the connector illustrated in FIG. 1 is disassembled;

FIG. 3 is a perspective view illustrating a temperature sensor, a sensor holder, and a portion of the terminal holder to which the sensor holder is attached;

FIG. 4 is a front view of the terminal holder:

FIG. 5 is a cross-sectional view taken along a line B-B in FIG. 4;

FIG. 6 is a cross-sectional view taken along a line A-A in FIG. 1;

FIG. 7 is a view corresponding to FIG. 6 in which the terminal holder holding the terminal is mounted in the housing;

FIG. 8 is a cross-sectional view taken along a line C-C in FIG. 7;

FIG. 9 is a cross-sectional view taken along a line D-D in FIG. 7; and

FIG. 10 is a cross-sectional view taken along a line E-E in FIG. 7.

### DESCRIPTION OF EMBODIMENTS

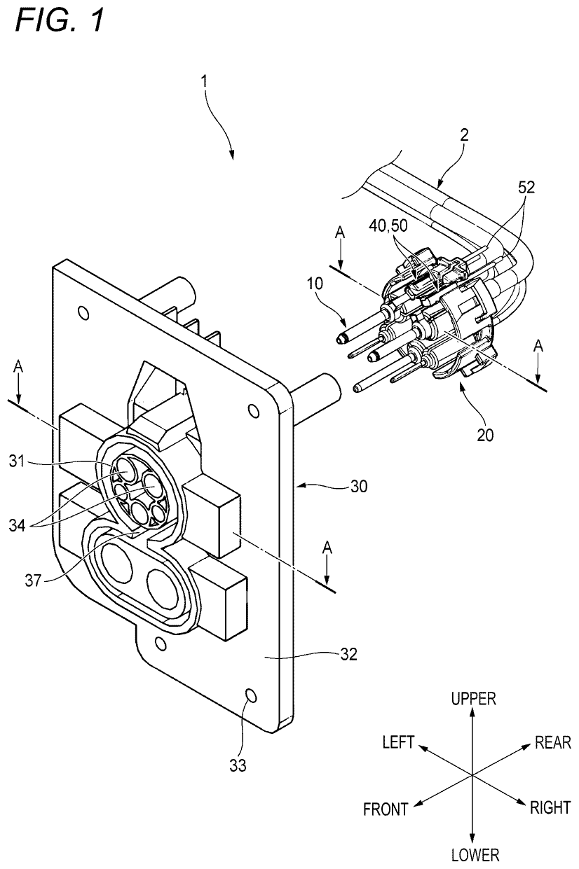

Hereinafter, a connector 1 according to an embodiment of the present invention will be described with reference to the drawings. The connector 1 is a connector that is installed in a vehicle such as an electric automatic vehicle or a plug-in hybrid automatic vehicle and is connected to an electric wire 2 extending from a battery, equipment, or the like mounted in the vehicle. The connector 1 is also called a charging inlet. By fitting a counterpart connector (so-called charging gun) into an opening portion 37 for fitting (see FIG. 1) of the connector 1, electric power is supplied to a battery from a power supply or the like outside the vehicle, and the battery is charged.

Hereinafter, for convenience of description, as illustrated in FIGS. 1 to 10, a “front-rear direction”, a “left-right direction”, and an “upper-lower direction” are defined. The “front-rear direction”, the “left-right direction”, and the “upper-lower direction” are orthogonal to one another. The front-rear direction corresponds to a fitting direction of the connector 1 and the counterpart connector, and a forward side and a backward side of the fitting of the connector 1 to the counterpart connector correspond to “front” and “rear”, respectively.

As illustrated in FIGS. 1 to 3, the connector 1 includes a plurality of terminals 10, a terminal holder 20 holding the plurality of terminals 10, a housing 30 to which the terminal holder 20 is mounted, a sensor holder 40 mounted to the terminals 10, and a temperature sensor 50 held by the sensor holder 40. Hereinafter, components constituting the connector 1 will be described in order.

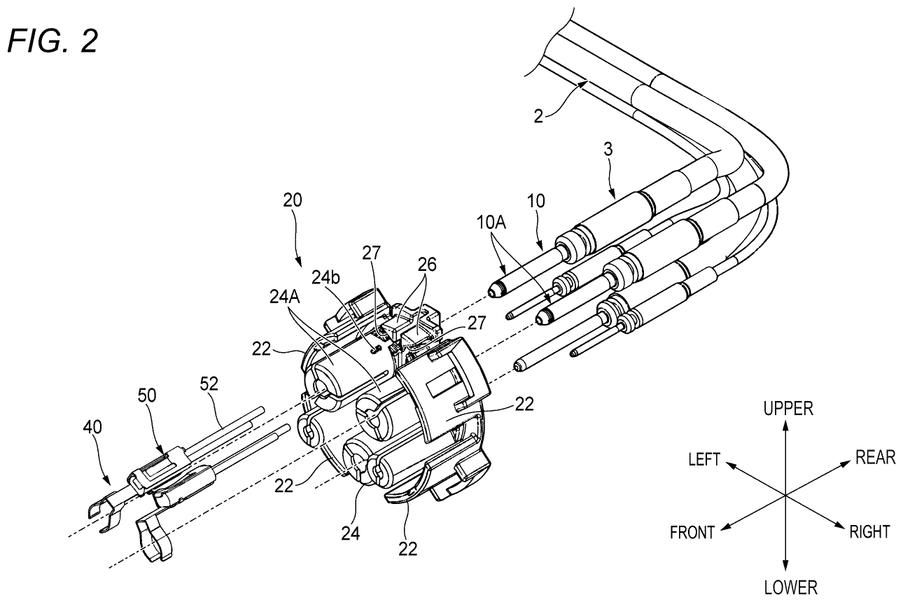

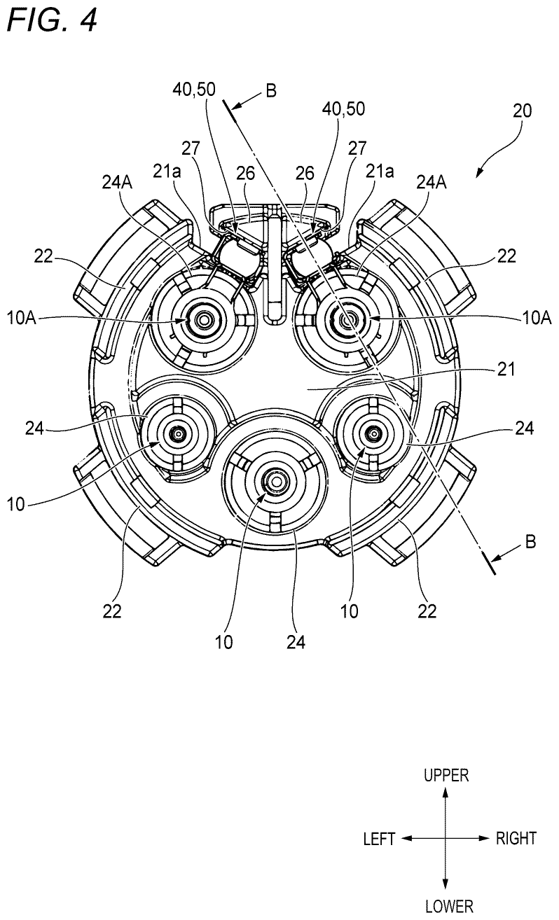

First, the plurality of terminals 10 will be described. In this example, as illustrated in FIG. 2 and the like, the plurality of (specifically, five) terminals 10 include a pair of terminals 10 having the same shape and the largest diameter, a pair of terminals 10 having the same shape and the smallest diameter, and a single terminal 10 having an intermediate diameter. The sensor holder 40 is mounted only to the pair of terminals 10 having the largest diameter, and is not mounted to the other three terminals 10 (see FIG. 4 and the like). Hereinafter, each of the pair of terminals 10 having the same shape and the largest diameter is referred to as a “terminal 10A” (see FIG. 2 and the like) only when it is necessary to distinguish from the other terminals 10. The pair of terminals 10A having the largest diameter are terminals for power supply used for the above-described charging or the like. The pair of terminals 10 having the smallest diameter are terminals for signal transmission (signal), and the single terminal 10 having the intermediate diameter is a terminal for ground (GND). The number of the terminals 10 used in the connector 1, a size (thickness) of a diameter of the terminals 10, a relationship between the diameters of the terminals 10, and the like are not limited to those described in the present embodiment.

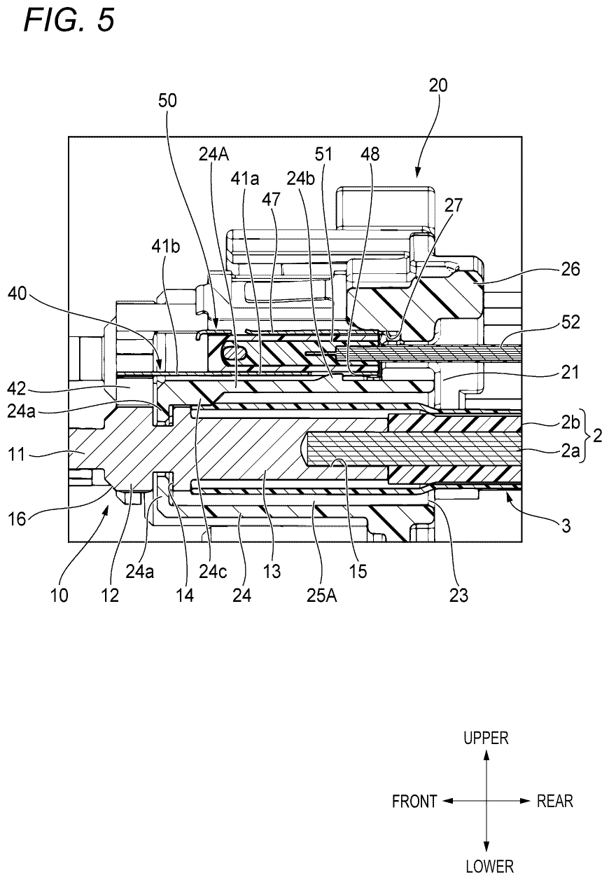

The terminal 10 is made of metal. As illustrated in FIG. 5, the terminal 10 is a male terminal having a stepped cylindrical rod shape including a small-diameter portion 11, a large-diameter portion 12 positioned behind the small-diameter portion 11, and an intermediate-diameter portion 13 positioned behind the large-diameter portion 12. Between the small-diameter portion 11 and the large-diameter portion 12, a coupling portion 16 is formed which connects the small-diameter portion 11 and the large-diameter portion 12 while gradually increasing in diameter from the small-diameter portion 11 toward the large-diameter portion 12. When the connector 1 is fitted to the counterpart connector, the small-diameter portion 11 of the terminal 10 is connected to a female terminal (not illustrated) of the counterpart connector.

An annular groove portion 14 is formed on an outer peripheral surface of the large-diameter portion 12. When the terminal 10 is assembled to the terminal holder 20, a locking protrusion 24a of an elastic locking piece 24 to be described later of the terminal holder 20 is fitted into the annular groove portion 14 (see FIG. 5).

One end portion of the electric wire 2 (see FIGS. 1 and 2) is connected to a rear end portion of the intermediate-diameter portion 13. The other end portion of the electric wire 2 is connected to a power supply source (not illustrated). Specifically, the electric wire 2 includes a conductor core wire 2a and a sheath 2b made of an insulating resin and covering the conductor core wire 2a (see FIG. 5). A recessed portion 15 recessed forward is formed in a rear end surface of the intermediate-diameter portion 13 (see FIG. 5). The conductor core wire 2a exposed at the one end portion of the electric wire 2 is inserted into the recessed portion 15 and is fixed by crimping. Thus, the terminal 10 and the one end portion of the electric wire 2 are electrically connected. In this example, further, as illustrated in FIGS. 2 and 5, a tubular exterior member 3 is provided so as to cover a predetermined region in the front-rear direction including a connection portion between the terminal 10 and the electric wire 2. The plurality of terminals 10 have been described above.

Next, the terminal holder 20 will be described. The terminal holder 20 is a resin molded product, and integrally includes a rear wall portion 21 (see FIGS. 4 and 5) having a substantially circular flat plate shape and constituting a rear end portion of the terminal holder 20, and a plurality of (four in this example) extending portions 22 (see FIGS. 2 to 4) extending forward from different positions in a circumferential direction of a periphery edge of the rear wall portion 21. In this example, the four extending portions 22 protrude forward from four periphery edges of the rear wall portion 21 at four positions excluding both upper and lower end portions and both left and right end portions thereof, and each of the extending portions 22 extends in an arc shape along the periphery edge of the rear wall portion 21 (as viewed from the front). A notch portion 21a recessed downward is formed in an upper end portion of the rear wall portion 21 (see FIG. 4).

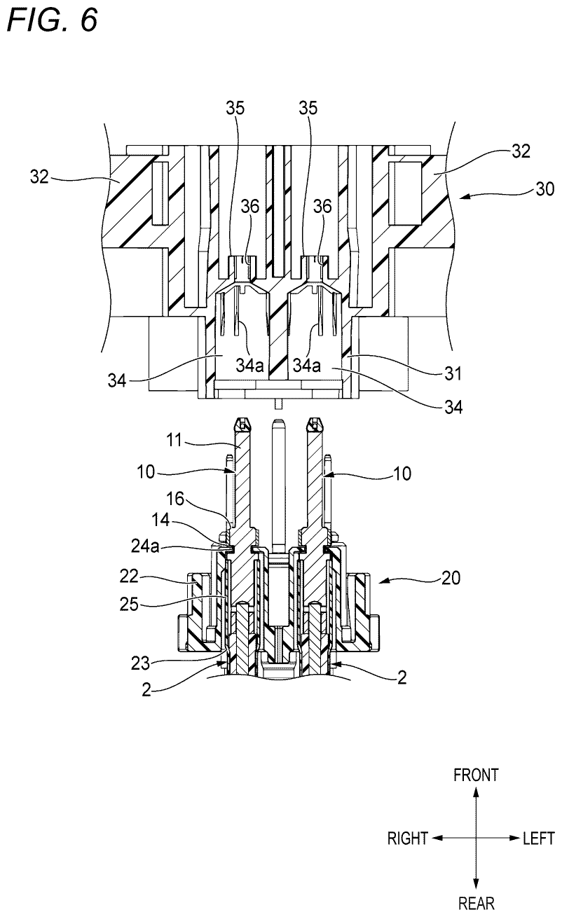

In a region inward in a radial direction of the periphery edge of the rear wall portion 21, a plurality of (five in this example) circular through holes 23 are formed at intervals from each other corresponding to the plurality of terminals 10 (see FIGS. 5 and 6). A plurality of elastic locking pieces 24 extend forward from a plurality of different positions in the circumferential direction of the periphery edge of each through holes 23 so as to define a terminal insertion hole 25 continuously extending forward from the through hole 23 (see FIGS. 5 and 6) (see FIGS. 2 to 4 and the like). Each elastic locking piece 24 extends in an arc shape along the periphery edge of the through hole 23 (as viewed from the front). The terminal 10 is inserted into each terminal insertion hole 25 from the rear side through the through hole 23.

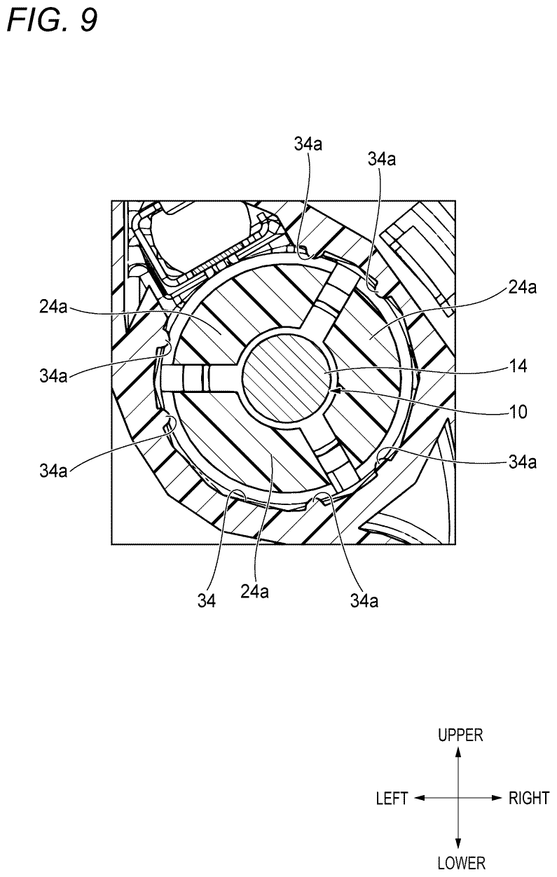

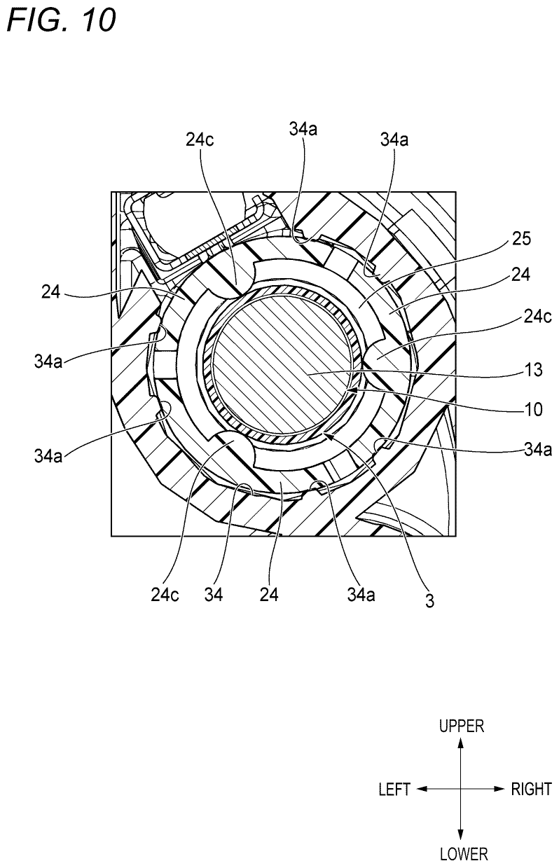

Each elastic locking piece 24 has a cantilever shape and is elastically deformable in the radial direction of the terminal insertion hole 25. The locking protrusion 24a extending inward in the radial direction of the terminal insertion hole 25 is formed on a tip end portion (front end portion) of each elastic locking piece 24 (see FIGS. 5 and 9). Further, on an inner peripheral surface of a portion in a vicinity of a tip end of each elastic locking piece 24, a projecting strip portion 24c protruding inward in the radial direction is formed so as to extend rearward from the locking protrusion 24a (see FIGS. 5 and 10). The effect of providing the projecting strip portion 24c will be described later.

A diameter dimension of each through hole 23 corresponds to a diameter dimension of the corresponding terminal 10. Accordingly, a diameter dimension of the terminal insertion hole 25 defined by the plurality of elastic locking pieces 24 extending from the periphery edge of each through hole 23 also corresponds to the diameter dimension of the corresponding terminal 10. As illustrated in FIG. 4 and the like, the pair of through holes 23 (and the pair of terminal insertion holes 25) having the largest diameter corresponding to the pair of terminals 10A having the largest diameter are disposed to be spaced apart from each other at an interval in the left-right direction at a position above a center in the upper-lower direction of the rear wall portion 21. Hereinafter, each of the pair of terminal insertion holes 25 having the largest diameter is referred to as a “terminal insertion hole 25A” (see FIG. 5) only when it is necessary to distinguish from the other terminal insertion holes 25.

As can be understood from FIG. 4, each of the pair of terminal insertion holes 25A and the single terminal insertion hole 25 corresponding to the single terminal 10 having the intermediate diameter are each defined by three elastic locking pieces 24 arranged at equal intervals in the circumferential direction of the terminal insertion hole 25, and each of the terminal insertion holes 25 corresponding to the pair of terminals 10 having the smallest diameter is defined by two elastic locking pieces 24 arranged at equal intervals in the circumferential direction of the terminal insertion hole 25.

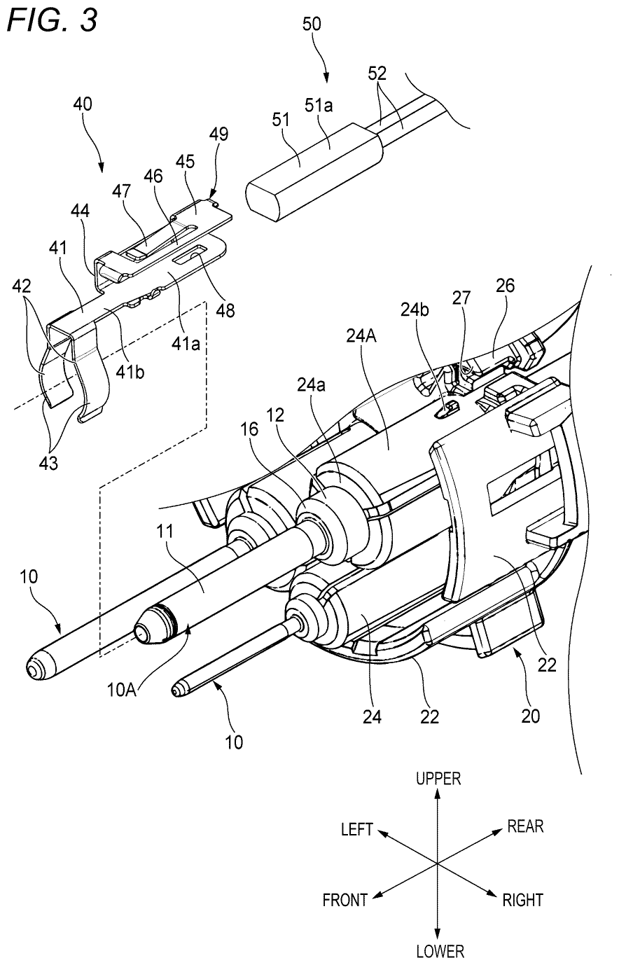

Among the plurality of (three) elastic locking pieces 24 defining each of the pair of terminal insertion holes 25A, an outer peripheral surface of the elastic locking piece 24 (hereinafter, referred to as “elastic locking piece 24A” (see FIGS. 2 to 5)) disposed at a position facing the notch portion 21a of the rear wall portion 21 as viewed from the front is provided with a locking protrusion 24b protruding toward the notch portion 21a (see FIGS. 2, 3, and 5). The locking protrusion 24b is engaged with a locking hole 48 (see FIGS. 3 and 5) of the sensor holder 40.

The notch portions 21a (see FIG. 4) of the rear wall portion 21 are provided with holding walls 26 (see FIGS. 2 to 5) having a pair of facing surfaces (flat surfaces) 27 disposed to face the outer peripheral surfaces of the pair of elastic locking pieces 24A with a predetermined interval therebetween, respectively. Between the outer peripheral surface of the elastic locking piece 24A and the facing surface 27, a rear end portion of a sensor holding portion 49 to be described later of the sensor holder 40 is inserted and held (see FIGS. 4 and 5). The terminal holder 20 has been described above.

Next, the housing 30 will be described. As illustrated in FIG. 1, the housing 30 is a resin molded product and includes a cylindrical tubular portion 31 extending in the front-rear direction and a flange portion 32 protruding outward in the radial direction from an outer peripheral surface of the tubular portion 31. The flange portion 32 has a substantially rectangular outer peripheral shape as viewed in the front-rear direction. Bolt insertion holes 33 penetrating in the front-rear direction are formed at a plurality of positions on a periphery edge portion of the flange portion 32. A bolt (not illustrated) for fixing the connector 1 to a predetermined mounting portion of the vehicle is inserted into the bolt insertion hole 33.

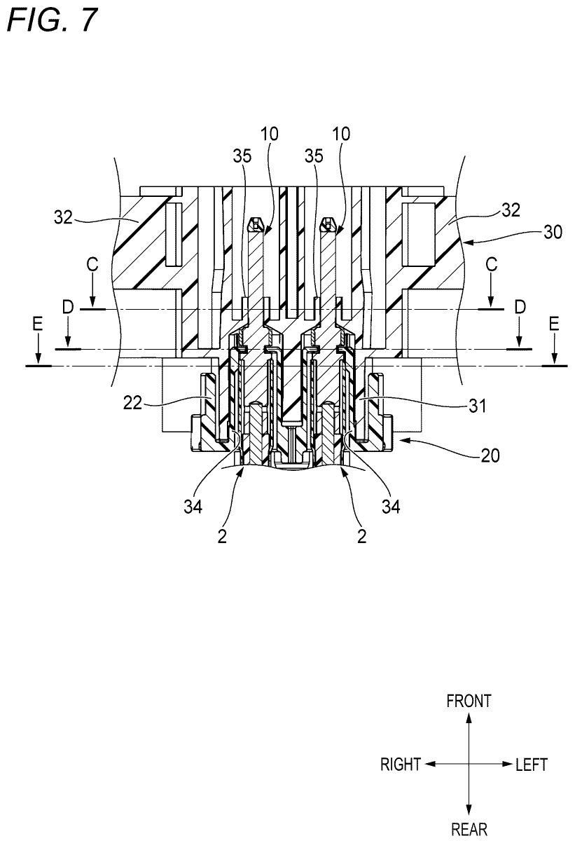

A plurality of (five) terminal accommodating chambers 34 are formed in the tubular portion 31 so as to penetrate in the front-rear direction corresponding to the plurality of through holes 23 (terminal insertion holes 25) of the terminal holder 20 (see FIGS. 1 and 6). When the terminal holder 20 is assembled into the housing 30, the corresponding terminal 10 is inserted into each terminal accommodating chamber 34 from the rear side (see FIG. 7). A diameter dimension of each terminal accommodating chamber 34 corresponds to the diameter dimension of the corresponding terminal 10. As described above, the number, the thickness, and the like of the terminals 10 used in the connector 1 are not limited to those described in the present embodiment. Similarly, the number, size, and the like of the terminal accommodating chambers 34 may be appropriately determined based on the number, thickness, and the like of the terminals 10, and are not limited to the contents described in the present embodiment.

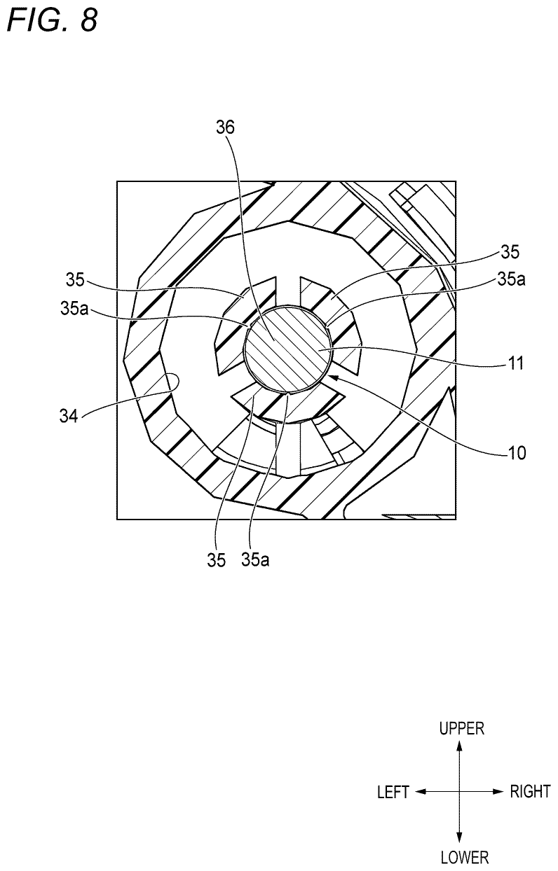

As illustrated in FIGS. 6 and 8, a plurality of elastic pieces 35 extend inward in the radial direction and forward from different positions in the circumferential direction at a predetermined position in the front-rear direction on an inner peripheral surface of each terminal accommodating chamber 34 so as to define an insertion hole 36 having a diameter smaller than that of the terminal accommodating chamber 34 and penetrating in the front-rear direction. In this example, each insertion hole 36 is defined by three elastic pieces 35 arranged at equal intervals in the circumferential direction of the terminal accommodating chamber 34 (see FIG. 8). Each elastic piece 35 has a cantilever shape and is elastically deformable in a radial direction of the terminal accommodating chamber 34. When the terminal holder 20 is assembled into the housing 30, the small-diameter portion 11 of the corresponding terminal 10 is inserted into the corresponding insertion hole 36 (see FIG. 7). The effect of providing such an elastic piece 35 will be described later.

As illustrated in FIGS. 6 and 10, at a position behind the elastic piece 35 on the inner peripheral surface of each terminal accommodating chamber 34, projecting strip portions 34a protruding inward in the radial direction of the terminal accommodating chamber 34 and extending in the front-rear direction are formed at a plurality of positions in the circumferential direction. The effect of providing the projecting strip portion 34a will be described later. Hereinafter, the housing 30 has been described.

Next, the sensor holder 40 will be described. The sensor holder 40 has a function of holding the temperature sensor 50 (see FIG. 3) and transmitting heat generated by the terminal 10 to the temperature sensor 50. The sensor holder 40 is formed by pressing and bending a single metal plate.

As illustrated in FIG. 3, the sensor holder 40 includes a flat plate portion 41 extending in the front-rear direction and having rectangular flat plate shape. A pair of plate-shaped elastic pieces 42 are provided on both edge portions of a front end portion of the flat plate portion 41 in a width direction so as to extend toward one surface side of the flat plate portion 41 and face each other. The elastic pieces 42 are elastically deformable in directions facing each other. Each of the elastic pieces 42 is formed with a curved portion 43 protruding in an arc shape outward in the facing direction to correspond to an outer peripheral shape of the large-diameter portion 12 of the terminal 10. When the sensor holder 40 is mounted to the terminal 10, the curved portions 43 of the pair of elastic pieces 42 are assembled to the large-diameter portion 12 of the terminal 10 so as to cover an outer periphery of the large-diameter portion 12.

At one side edge in the width direction of a rear region 41a from substantially a center to a rear end in the front-rear direction of the flat plate portion 41, a standing wall portion 44 is provided so as to protrude toward the other surface side of the flat plate portion 41 and extend in the front-rear direction. A facing plate portion 45 is provided on an extending end edge of the standing wall portion 44 extending in the front-rear direction so as to protrude toward the other side in the width direction, extend in the front-rear direction, and face the rear region 41a.

A substantially rectangular notch portion 46 extending in the front-rear direction is formed in a central portion of the facing plate portion 45. The facing plate portion 45 is provided with a cantilever-shaped elastic piece 47 extending from a rear end edge of the notch portion 46 toward a front end edge so as to close the notch portion 46. The elastic piece 47 is elastically deformable in a direction facing the rear region 41a, and is slightly inclined in a direction approaching the rear region 41a during non-elastic deformation. A locking hole 48 penetrating in a plate thickness direction is formed in the rear region 41a.

A body portion 51 to be described later of the temperature sensor 50 is inserted and held between the rear region 41a and the facing plate portion 45. Thus, the rear region 41a, the standing wall portion 44, the facing plate portion 45, and the elastic piece 47 constitute the sensor holding portion 49. In the sensor holder 40, the pair of elastic pieces 42 correspond to a “terminal mounting portion” according to the present invention, the rear region 41a of the flat plate portion 41 corresponds to a “contact surface portion” according to the present invention, and a front region 41b on the front side of the rear region 41a of the flat plate portion 41 corresponds to a “heat transfer portion” according to the present invention. The sensor holder 40 has been described above.

Next, the temperature sensor 50 will be described. As illustrated in FIG. 3, the temperature sensor 50 includes the body portion 51 having a thermistor therein. In this example, the body portion 51 has a substantially rectangular parallelepiped shape extending in the front-rear direction, and has a pair of flat surfaces 51a disposed in parallel to each other and extending in the front-rear direction on an outer surface thereof. A pair of electric wires 52 connected to the thermistor extends from a rear end of the body portion 51. The components constituting the connector 1 have been described above.

Next, assembly of the connector 1 will be described. In order to assemble the connector 1, first, the plurality of terminals 10 are assembled to the terminal holder 20 and the temperature sensor 50 is assembled to the sensor holder 40. There is no limitation before and after assembling both.

First, assembly of the plurality of terminals 10 to the terminal holder 20 will be described. Each terminal 10 to which one end portion of the electric wire 2 is connected and to which the exterior member 3 is provided is inserted into the corresponding terminal insertion hole 25 of the terminal holder 20 from the rear side (see FIG. 5). This insertion is completed (see FIGS. 5 and 9) through a stage in which the plurality of elastic locking pieces 24 are temporarily elastically deformed outward in the radial direction by the pressing of the terminal 10 from the coupling portion 16 and the large-diameter portion 12 against the locking protrusions 24a of the plurality of elastic locking pieces 24 defining the terminal insertion hole 25, and then the plurality of locking protrusions 24a are fitted into the annular groove portion 14 of the large-diameter portion 12 by elastic restoration of the plurality of elastic locking pieces 24 inward in the radial direction. When the insertion of all the plurality of terminals 10 is completed, the assembly of the plurality of terminals 10 to the terminal holder 20 is completed.

In a state in which the insertion of the terminal 10 into the terminal holder 20 is completed, the large-diameter portion 12 and the intermediate-diameter portion 13 of the terminal 10 are surrounded in the circumferential direction by the plurality of elastic locking pieces 24 (see FIG. 5), and movement of the terminal 10 in the radial direction and the front-rear direction with respect to the terminal holder 20 is restricted by the fitting of the plurality of elastic locking pieces 24 into the annular groove portion 14 of the large-diameter portion 12. Further, as illustrated in FIGS. 5 and 10, the projecting strip portions 24c of the plurality of elastic locking pieces 24 arranged at equal intervals in the circumferential direction press the outer peripheral surface of the terminal 10 (specifically, the outer peripheral surface of the portion corresponding to the large-diameter portion 12 and the intermediate-diameter portion 13) inward in the radial direction. Accordingly, positional deviation in the radial direction of the terminal 10 is prevented.

Next, the assembly of the temperature sensor 50 to the sensor holder 40 will be described. This assembly is completed by inserting the body portion 51 of the temperature sensor 50 into the sensor holding portion 49 of the sensor holder 40 from the rear side with the pair of flat surfaces 51a facing the rear region 41a and the elastic pieces 47 of the sensor holder 40.

In a state in which the temperature sensor 50 is completely assembled to the sensor holder 40, the elastic piece 47 elastically presses the body portion 51 toward the rear region 41a. Therefore, the flat surface 51a of the body portion 51 and the rear region (flat surface) 41a facing each other are maintained in a state in which they are in face-to-face contact while being pressed against each other. Accordingly, a temperature of the terminal 10 can be appropriately measured by accurately transmitting the heat of the terminal 10 to the temperature sensor 50 through the sensor holder 40.

As described above, when the assembly of the plurality of terminals 10 to the terminal holder 20 and the assembly of the temperature sensor 50 to the sensor holder 40 are completed, the assembly of the sensor holder 40 to the terminal 10A is performed. The sensor holder 40 to which the temperature sensor 50 is assembled is assembled to each of the pair of terminals 10A assembled to the terminal holder 20.

Specifically, the sensor holder 40 is moved rearward relative to the terminal 10A (terminal holder 20) such that the rear end portion of the sensor holding portion 49 of the sensor holder 40 is inserted between the outer peripheral surface of the elastic locking piece 24A and the facing surface 27 of the holding wall 26 in a state in which the small-diameter portion 11 of the terminal 10A is inserted into a space between the pair of elastic pieces 42 of the sensor holder 40. This movement progresses while an amount of elastic deformation of the pair of elastic pieces 42 in a direction away from each other gradually increases due to the pressing of the pair of elastic pieces 42 from the coupling portion 16 of the terminal 10A, and is completed when the elastically deformed pair of elastic pieces 42 reaches a position where the pair of elastic pieces 42 sandwich the large-diameter portion 12 of the terminal 10A. Thus, the assembly of the sensor holder 40 to the terminal 10A is completed.

In a state in which the sensor holder 40 is completely assembled to the terminal 10A, the pair of elastic pieces 42 are assembled while being in press-contact with the outer peripheral surface of the large-diameter portion 12 such that the curved portions 43 of the pair of elastic pieces 42 cover the outer peripheral surface of the large-diameter portion 12 of the terminal 10. Accordingly, the heat of the terminal 10A is appropriately transferred to the pair of elastic pieces 42 of the sensor holder 40. The heat of the terminal 10A transferred to the pair of elastic pieces 42 is transferred to the body portion 51 (flat surface 51a) of the temperature sensor 50 which is in face-to-face contact with the rear region 41a through the front region 41b and the rear region 41a of the sensor holder 40 in this order.

The rear end portion of the sensor holding portion 49 of the sensor holder 40 is sandwiched and held between the outer peripheral surface of the elastic locking piece 24A and the facing surface 27 of the holding wall 26, and the locking hole 48 of the sensor holder 40 is engaged with the locking protrusion 24b of the terminal holder 20 (see FIG. 5). Thus, the sensor holder 40 is firmly fixed to the terminal holder 20. In this manner, in a state in which the sensor holder 40 is firmly fixed to the terminal holder 20, the body portion 51 of the temperature sensor 50 is separated from the terminal 10A and is not in contact with any portion of the terminal 10A (see FIG. 5).

As described above, when the assembly of the sensor holder 40 to the terminal 10A is completed, next, the terminal holder 20 is assembled to the housing 30. Specifically, as illustrated in FIGS. 6 and 7, the terminal holder 20 is assembled to the housing 30 such that the small-diameter portions 11 of the plurality of terminals 10 exposed to protrude forward from the plurality of terminal insertion holes 25 of the terminal holder 20 are inserted into the plurality of terminal accommodating chambers 34 of the housing 30 from the rear side and the tubular portion 31 of the housing 30 enters a space defined by the plurality of extending portions 22 of the terminal holder 20.

In a state in which the terminal holder 20 is completely assembled to the housing 30, as illustrated in FIGS. 7 and 10, the plurality of projecting strip portions 34a provided in the terminal accommodating chamber 34 of the housing 30 press the outer peripheral surfaces of the plurality of elastic locking pieces 24 surrounding the large-diameter portion 12 and the intermediate-diameter portion 13 of the terminal 10 in the circumferential direction inward in the radial direction. Accordingly, it is possible to prevent the engagement between the locking protrusions 24a of the plurality of elastic locking pieces 24 and the annular groove portion 14 of the large-diameter portion 12 of the terminal 10 from being unintentionally released (see FIGS. 5 and 6).

As illustrated in FIG. 10, the plurality of projecting strip portions 34a of the housing 30 and the plurality of projecting strip portions 24c of the terminal holder 20 are disposed to be offset from each other in the circumferential direction of the terminal 10. Accordingly, a pressing force generated by the projecting strip portion 34a and projecting strip portion 24c is appropriately dispersed in the circumferential direction, and the positional deviation of the terminal 10 in the radial direction is more strongly prevented.

As illustrated in FIGS. 7 and 8, the small-diameter portion 11 of the terminal 10 is inserted into the insertion hole 36 defined by the plurality of elastic pieces 35, and the plurality of elastic pieces 35 arranged at equal intervals in the circumferential direction elastically press the small-diameter portion 11 of the terminal 10 inward in the radial direction. A protrusion portion 35a protruding toward the small-diameter portion 11 of the terminal 10 is provided on a surface inward in the radial direction of each of the plurality of elastic pieces 35. The contact of the protrusion portion 35a with the small-diameter portion 11 of the terminal 10 further prevent the positional deviation of the terminal 10 in the radial direction. As described above, when the assembly of the terminal holder 20 to the housing 30 is completed, the assembly of the connector 1 is completed.

As described above, according to the connector 1 of the present embodiment, the plurality of locking portions (elastic locking pieces) 24 elastically displaceable in the radial direction are provided in the terminal holder 20. The plurality of locking portions 24 are disposed so as to surround the rod-shaped terminal 10 in the circumferential direction and engage with the terminal 10 to restrict movement of the terminal 10 in the radial direction and an axial direction. Accordingly, the terminal 10 can be appropriately held by the terminal holder 20 without using a rear holder or the like used in the above connector of the related art. By mounting the housing 30 on the terminal holder 20 holding the terminal 10 in this manner, the plurality of locking portions 24 are pressed inward in the radial direction by first pressing portions (projecting strip portions) 34a of the housing 30. That is, the first pressing portions 34a prevent the plurality of locking portions 24 from unintentionally coming from the terminal 10. Even when the plurality of terminals 10 are accommodated in the connector 1, each terminal 10 can be appropriately held by the terminal holder 20 and the first pressing portions 34a as described above. As described above, in the connector 1 according to the present embodiment, an assembling work of each member is easier than that in the connector of the related art, and thus workability of manufacturing the connector 1 can be improved.

The housing 30 includes second pressing portions (elastic piece) 35 that press the terminal 10 inward in the radial direction. Accordingly, the positional deviation in the radial direction of the terminal 10 is more strongly prevented by the action of the second pressing portion 35.

The terminal holder 20 includes third pressing portions (projecting strip portions) 24c that press the terminal 10 inward in the radial direction, in addition to the plurality of locking portions 24. Accordingly, the positional deviation in the radial direction of the terminal 10 is more strongly prevented by the action of the third pressing portion 24c.

In the terminal holder 20, the plurality of elastic locking pieces 24 are arranged at equal intervals in the circumferential direction of the terminal 10. Accordingly, positional deviation in the radial direction of the terminal 10 is more strongly prevented.

The first pressing portions 34a that press the locking portion 24 of the terminal holder 20 and the third pressing portions 24c that press the terminal 10 are disposed to be offset from each other in the circumferential direction of the terminal 10. Accordingly, the pressing force generated by the first pressing portion 34a and the third pressing portion 24c is appropriately dispersed in the circumferential direction, and the positional deviation of the terminal 10 in the radial direction is more strongly prevented.

The present invention is not limited to the embodiment described above, and various modifications can be adopted within the scope of the present invention. For example, the invention is not limited to the embodiment described above, and modifications, improvements, and the like can be made appropriately. In addition, materials, shapes, sizes, numbers, arrangement positions, or the like of components in the embodiment described above are freely selected and are not limited as long as the present invention can be implemented.

For example, in the above embodiment, the plurality of projecting strip portions 34a (first pressing portions) are formed at a plurality of positions in the circumferential direction of the inner peripheral surface of the terminal accommodating chamber 34. In contrast, a single projecting strip portion 34a may be formed at one position in the circumferential direction of the inner peripheral surface of the terminal accommodating chamber 34.

In the above embodiment, the plurality of elastic pieces 35 (second pressing portions) are provided on the inner peripheral surface of the terminal accommodating chamber 34 of the housing 30, and the projecting strip portion 24c (third pressing portion) is provided on the inner peripheral surface of the elastic locking piece 24 of the terminal holder 20. In contrast, one or both of the elastic piece 35 and the projecting strip portion 24c may be omitted.

Here, in the embodiment described above of the present invention, a connector (1) includes:
a rod-shaped terminal (10);
a terminal holder (20) configured to hold the terminal (10); and
a housing (30) to which the terminal holder (20) is mounted, in which
the terminal holder (20) includes a plurality of locking portions (24) arranged in a circumferential direction of the terminal (10), the plurality of locking portions being elastically displaceable in a radial direction of the terminal (10) and being capable of engaging with the terminal (10) to restrict movement of the terminal (10) in the radial direction and an axial direction, and
the housing (30) includes one or more first pressing portions (34a) that press the plurality of locking portions (24) of the terminal holder (20) inward in the radial direction.

According to the connector having the above configuration, the plurality of locking portions elastically displaceable in the radial direction are provided in the terminal holder. The plurality of locking portions are disposed so as to surround the rod-shaped terminal in the circumferential direction and engage with the terminal to restrict movement of the terminal in the radial direction and the axial direction. Accordingly, the terminal can be appropriately held by the terminal holder without using a rear holder or the like used in the above connector of the related art. By mounting the housing on the terminal holder holding the terminal in this manner, the plurality of locking portions are pressed inward in the radial direction by the first pressing portion of the housing. That is, the first pressing portion prevents the plurality of locking portions from unintentionally coming from the terminal. Even when the plurality of terminals are accommodated in the connector, each terminal can be appropriately held by the terminal holder and the first pressing portion as described above. As described above, in the connector according to the present embodiment, an assembling work of each member is easier than that in the connector of the related art, and thus workability of manufacturing the connector can be improved.

The housing (30) may further include a second pressing portion (35, 35a) that presses the terminal (10) inward in the radial direction.

According to the connector having the above configuration, the housing includes the second pressing portion that presses the terminal inward in the radial direction. Accordingly, positional deviation in the radial direction of the terminal is more strongly prevented by the action of the second pressing portion.

The terminal holder (20) may further include a third pressing portion (24c) that presses the terminal (10) inward in the radial direction.

According to the connector having the above configuration, the terminal holder includes the third pressing portion that presses the terminal inward in the radial direction, in addition to the plurality of locking portions. Accordingly, the positional deviation in the radial direction of the terminal is more strongly prevented by the action of the third pressing portion.

The terminal holder (20) may include the plurality of locking portions (24) arranged at equal intervals in the circumferential direction of the terminal (10).

According to the connector having the above configuration, the plurality of locking pieces are arranged in the terminal holder at equal intervals in the circumferential direction of the terminal. Accordingly, the positional deviation in the radial direction of the terminal is more strongly prevented.

The first pressing portion (34a) and the third pressing portion (24c) may be disposed to be offset from each other in the circumferential direction of the terminal (10).

According to the connector having the above configuration, the first pressing portion that presses the locking portion of the terminal holder and the third pressing portion that presses the terminal are disposed to be offset from each other in the circumferential direction of the terminal. Accordingly, a pressing force generated by the first pressing portion and the third pressing portion is appropriately dispersed in the circumferential direction, and the positional deviation of the terminal in the radial direction is more strongly prevented.

The present application is based on a Japanese patent application (Japanese Patent Application No. 2022-036374) filed on Mar. 9, 2022, and the contents thereof are incorporated herein by reference.

### INDUSTRIAL APPLICABILITY

The connector according to the present invention is capable of improving workability OF manufacturing the connector. The present invention having this effect can be used, for example, in a charging inlet device that is mounted on an electric automatic vehicle or the like and is for charging a battery.

What is claimed is:

1. A connector comprising:
a rod-shaped terminal;
a terminal holder configured to hold the terminal; and
a housing to which the terminal holder is mounted, wherein
the terminal holder includes a plurality of locking portions arranged in a circumferential direction of the terminal, the plurality of locking portions being elastically displaceable in a radial direction of the terminal and being capable of engaging with the terminal to restrict movement of the terminal in the radial direction and an axial direction, and
the housing includes
one or more first pressing portions that press the plurality of locking portions of the terminal holder inward in the radial direction, and
a second pressing portion that presses the terminal inward in the radial direction.

2. The connector according to claim 1, wherein
the plurality of locking portions of the terminal holder are arranged at equal intervals in the circumferential direction of the terminal.

3. The connector according to claim 1, wherein
each of the plurality of locking portions includes a locking protrusion extending toward the terminal.

4. The connector according to claim 1, wherein
each of the plurality of locking portions has a cantilever shape.

5. A connector comprising:
a rod-shaped terminal;
a terminal holder configured to hold the terminal; and
a housing to which the terminal holder is mounted, wherein
the terminal holder includes a plurality of locking portions arranged in a circumferential direction of the terminal, the plurality of locking portions being elastically displaceable in a radial direction of the terminal and being capable of engaging with the terminal to restrict movement of the terminal in the radial direction and an axial direction,
the housing includes one or more first pressing portions that press the plurality of locking portions of the terminal holder inward in the radial direction,
the terminal holder includes a third pressing portion that presses the terminal inward in the radial direction, and
the first pressing portion and the third pressing portion are disposed to be offset from each other in the circumferential direction of the terminal.

6. The connector according to claim 5, wherein
the plurality of locking portions of the terminal holder are arranged at equal intervals in the circumferential direction of the terminal.

7. The connector according to claim 5, wherein
each of the plurality of locking portions includes a locking protrusion extending toward the terminal.

8. The connector according to claim 5, wherein
each of the plurality of locking portions has a cantilever shape.
